(19) United States
(12) Patent Application Publication
(10) Pub. No.: US 2026/0104532 A1
(43) Pub. Date: Apr. 16, 2026

(54) WEATHER FORECAST PARALLEL PROCESSING USING STATISTICAL TRANSFORMATION MODELING

(71) Applicant: Salient Predictions, Inc., Cambridge, MA (US)

(72) Inventors: Fran Bartolic, New York, NY (US); Sean Ridge, New York, NY (US)

(73) Assignee: Salient Predictions, Inc., Cambridge, MA (US)

(21) Appl. No.: 19/357,314

(22) Filed: Oct. 14, 2025

Related U.S. Application Data
(60) Provisional application No. 63/707,514, filed on Oct. 15, 2024.

(51) Int. Cl. G01W 1/10; G01W 1/02; G06N 7/01

(52) U.S. Cl. CPC G01W 1/10; G01W 1/02; G06N 7/01

(57) ABSTRACT

The present solution is directed to systems and methods for weather forecasting systems to generate reliable long-term weather predictions over large geographical areas while maintaining high resolution and accuracy and conserving computational resources. The solution can identify a dataset comprising variables indicative of characteristics of weather during a first time interval and determine, based on the dataset, parameters of marginal distributions of the variables using a first function for maximum likelihood estimation and a second function for probability weighted moment matching of the parameters. The solution can construct, based on the variables, a correlation matrix configured for parallel processing and generate, via parallel processing by the one or more processors and based on the correlation matrix, predicted sample of variables for a weather forecast indicating the characteristics of weather during a second time interval. The solution can provide, for display, the predicted sample for weather forecast via a user interface.

### CROSS-REFERENCE TO RELATED APPLICATIONS

This application claims the benefit of priority under 35 U.S.C. § 119 to U.S. Provisional Ser. No. 63/707,514, titled “WEATHER FORECAST PARALLEL PROCESSING USING STATISTICAL TRANSFORMATION MODELING,” filed Oct. 15, 2024, which is hereby incorporated by reference herein in its entirety and for all purposes.

### INTRODUCTION

Weather forecasting can be implemented using modeling techniques processing different meteorological data to predict various atmospheric conditions. These predictions can be configured for different time periods and different geographical areas. Implementing such models can involve substantial computational resources to process large datasets, often with limited accuracy and reliability.

### SUMMARY

Weather forecasting faces challenges in generating long-term, high-resolution predictions over large areas while maintaining accuracy and computational efficiency. Machine learning models utilized for these purposes can struggle with unrealistic predictions when capturing complex atmospheric relationships due to unconstrained variables, resulting in unreasonable outputs (e.g., hallucinations). To overcome these issues, the technical solutions of this disclosure provides a weather forecasting solution that combines a Non-parametric Joint Distribution Model (NJDM) with a diffusion-based deep learning model. This hybrid system can process constraint-bound data using Nataf transformation and reintroduce fine-grained details to improve the weather forecasting resolution for large-area, long-term forecasts. In doing so, the technical solutions can reduce the risk of machine learning hallucinations and improve the processing efficiency of the solution, while also conserving the computational resources and improving the energy efficiency of the system.

An aspect of the technical solutions is directed to a system. The system can include one or more processors, coupled with memory. The one or more processors can be configured (e.g., via instructions and data stored in the memory) to determine, based on principle component analysis (PCA), latent variables that can correspond to characteristics of weather over the time interval in the geographical area. The one or more processors can construct, with a non-parametric joint distribution model (NJDM), a two-dimensional (2D) array of parameters that represents weather over a time interval in a geographical area. The one or more processors can generate, using a diffusion model, based on the latent variables and the 2D array, one or more predictions of 2D characteristics of weather over a second time interval for the geographical area.

The one or more processors can be configured to identify, from a database of meteorological data, the parameters. The parameters can correspond to at least one of: temperature, wind, humidity or a total column water vapor. The one or more processors can be configured to determine one or more marginal distributions for each of the parameters. The one or more processors can be configured to determine one or more correlation matrices identifying relationships between the parameters. The one or more processors are configured to adjust, within the one or more correlation matrices, eigenvalues corresponding to the parameters to achieve positive definiteness of the one or more correlation matrices.

The one or more processors can be configured to construct, using the NJDM, a joint distribution of the parameters indicative of interdependencies between the parameters. The one or more processors can be configured to determine, using the PCA applied to the joint distribution, the latent variables. The one or more processors can be configured to generate, using the one or more marginal distributions, constraints for the latent variables. The one or more processors can be configured to apply the constraints to the latent variables.

The constraints comprise at least one of: constraints for the characteristics of weather, a constraint for a relationship between two or more values of the two or more characteristics of weather, or a constraint for a temporal-spatial change for a value over a time period or a distance of space. The diffusion model can be a deep learning machine learning model trained using data indicative of the characteristics of weather for a plurality of weather representations within a plurality of time periods and a plurality of geographical areas.

The one or more processors can be configured to determine, based on the 2D array, representations of trends of weather in the geographical area. The one or more processors can be configured to determine based on the 2D array and the latent variables input into the diffusion model, representations of variations within the trends of weather. The one or more processors can be configured to combine, the representations of trends of weather and the representations of variations within the trends of weather to generate the one or more predictions of 2D characteristics of weather.

The one or more predictions of 2D characteristics of weather can include parameters indicative of at least one of: temperature, wind components and humidity. The one or more predictions of 2D characteristics of weather corresponds to daily predictions of weather in the geographical area for the second time interval of at least 30 consecutive days. The one or more processors can be configured to 2D array comprises a plurality of rows and a plurality of columns, wherein each entry of each individual row of the plurality of rows and each individual column of the plurality of columns corresponds to a parameter of the parameters corresponding to at least one of: pressure, temperature, saturation vapor pressure, vapor pressure deficit, specific humidity, air density, and wind speed.

An aspect of the technical solutions is directed to a method. The method can include one or more processors coupled with memory determining, based on principle component analysis (PCA), latent variables corresponding to characteristics of weather over the time interval in the geographical area. The method can include constructing, by the one or more processors, with a non-parametric joint distribution model (NJDM), a two-dimensional (2D) array of parameters that represents weather over a time interval in a geographical area. The method can include generating, by the one or more processors, using a diffusion model, based on the latent variables and the 2D array, one or more predictions of 2D characteristics of weather over a second time interval for the geographical area.

The method can include identifying, by the one or more processors, from a database of meteorological data, the parameters corresponding to at least one of: temperature, wind, humidity or a total column water vapor. The method can include determining one or more marginal distributions for each of the parameters. The method can include determining one or more correlation matrices identifying relationships between the parameters. The method can include adjusting, by the one or more processors, within the one or more correlation matrices, eigenvalues corresponding to the parameters to achieve positive definiteness of the one or more correlation matrices.

The method can include constructing, by the one or more processors, using the NJDM, a joint distribution of the parameters indicative of interdependencies between the parameters. The method can include determining, by the one or more processors, using the PCA applied to the joint distribution, the latent variables. The method can include generating, by the one or more processors, using the one or more marginal distributions, constraints for the latent variables. The method can include applying, by the one or more processors, the constraints to the latent variables. The constraints can include at least one of: constraints for the characteristics of weather, a constraint for a relationship between two or more values of the two or more characteristics of weather, or a constraint for a temporal-spatial change for a value over a time period or a distance of space.

The diffusion model can be a deep learning machine learning model trained using data indicative of the characteristics of weather for a plurality of weather representations within a plurality of time periods and a plurality of geographical areas. The method can include determining, by the one or more processors, based on the 2D array, representations of trends of weather in the geographical area. The method can include determining, by the one or more processors, based on the 2D array and the latent variables input into the diffusion model, representations of variations within the trends of weather. The method can include combining, by the one or more processors, the representations of trends of weather and the representations of variations within the trends of weather to generate the one or more predictions of 2D characteristics of weather.

The one or more predictions of 2D characteristics of weather can include parameters indicative of at least one of: temperature, wind components and humidity and wherein the one or more predictions of 2D characteristics of weather corresponds to daily predictions of weather in the geographical area for the second time interval of at least 30 consecutive days. The 2D array can include a plurality of rows and a plurality of columns. Each entry of each individual row of the plurality of rows and each individual column of the plurality of columns can correspond to a parameter of the parameters corresponding to at least one of: pressure, temperature, saturation vapor pressure, vapor pressure deficit, specific humidity, air density, and wind speed.

An aspect of the technical solutions is directed to a non-transitory computer-readable medium storing processor-executable instructions. The instructions, when executed by one or more processors, can cause the one or more processors to determine, based on principle component analysis (PCA), latent variables corresponding to characteristics of weather over the time interval in the geographical area. The instructions, when executed by one or more processors, can cause the one or more processors to construct, with a non-parametric joint distribution model (NJDM), a two-dimensional (2D) array of parameters that represents weather over a time interval in a geographical area. The instructions, when executed by one or more processors, can cause the one or more processors to generate, using a diffusion model, based on the latent variables and the 2D array, one or more predictions of 2D characteristics of weather over a second time interval for the geographical area.

An aspect of the technical solutions is directed to a system. The system can include one or more processors coupled with memory. The one or more processors can be configured to identify a dataset comprising variables indicative of characteristics of weather during a first time interval. The one or more processors can be configured to determine, based on the dataset, parameters of marginal distributions of the variables using a first function for maximum likelihood estimation and a second function for probability weighted moment matching of the parameters. The one or more processors can be configured to construct, based on the variables, a correlation matrix configured for parallel processing. The one or more processors can be configured to generate, via parallel processing by the one or more processors and based on the correlation matrix, predicted sample of variables for a weather forecast indicating the characteristics of weather during a second time interval. The one or more processors can be configured to provide, for display, the predicted sample of variables for the weather forecast via a user interface.

The dataset can comprise historical weather data collected from a meteorological station and the characteristics of weather correspond to at least one of: pressure, temperature, saturation vapor pressure, vapor pressure deficit, specific humidity, air density, cloud coverage, and wind speed. The distribution can include a Johnson SU probability distribution and the first function for maximum likelihood estimation is implemented using a gradient-based adjustment of the parameters. The gradient-based adjustment can be implemented using at least one of a function for Broyden-Fletcher-Goldfarb-Shanno (BFGS) operation or a function for Levenberg-Marquardt operation. The second function can utilize a Hessian matrix to iteratively refine the parameters using at least one second-order computation.

The one or more processors can be configured to normalize the probability distributions and construct the correlation matrix based on the variables of the dataset. The one or more processors can be configured to configured to determine values of the correlation matrix using a Pearson's correlation coefficient. The one or more processors can be configured to identify at least an entry of the correlation matrix corresponding to an eigenvalue that has a negative value. The one or more processors can be configured to modify the entry of the correlation matrix into a non-negative value to achieve positive definiteness of the correlation matrix.

The one or more processors can be configured to construct, based on the correlation matrix, a second matrix corresponding to correlated random variables. The one or more processors can be configured to generate, using the second matrix, a plurality of samples comprising the sample, the plurality of samples corresponding to the characteristics of weather. The one or more processors can be configured to generate, based on the plurality of samples, the weather forecast indicating the characteristics of weather during the second time interval.

The one or more processors can be configured to identify, from the one or more processors, a plurality of processors to perform the parallel processing. The one or more processors can be configured to determine a plurality of portions of predicted variables to process by the plurality of processors via parallel processing. The one or more processors can be configured to generate, by each processor of the plurality of processors during a same one or more processing cycles, a respective portion of the plurality of portions of predicted variables. For instance, each processor of the plurality of processors can generate a respective portion of the predicted variables during the same one or more processing cycles, enabling efficient parallel computation and reducing overall forecast generation time. A processing cycle can include, for example, a discrete interval during which each processor executes its assigned computational tasks, such as generating predicted variables before synchronizing results with other processors or proceeding to the next stage of parallel computation.

The one or more processors can be configured to determine, based on at least a subset of the predicted variables, forecast of wind movement in a geographical area during the second time interval. The one or more processors can be configured to identify, based on the forecast of the wind movement, a location within the geographical area in which the wind movement satisfies a constraint for a wind power plant. For example, a constraint for a wind power plant can specify a minimum average wind speed or a particular wind direction for a desired energy generation at a given location. The system can identify locations where the predicted wind movement meets or exceeds such predefined operational thresholds, thereby determining that the wind movement satisfies a constraint for the minimal amount of energy for the wind power plant. Satisfying a constraint can include the predicted wind movement meeting or exceeding a minimum threshold value (e.g., wind speed greater than or equal to a specified operational limit), being less than or equal to a maximum allowable value, or falling within a specified percentage range around a target value, depending on the operational requirements defined for the wind power plant.

The one or more processors can be configured to determine, based on at least a subset of the predicted variables, forecast of sunny weather in a geographical area during the second time interval. The one or more processors can be configured to identify, based on the forecast of the sunny weather, a location within the geographical area in which the sunny weather satisfies a constraint for a solar power plant. In some examples, satisfying a constraint can include the predicted sunny weather meeting or exceeding a minimum threshold duration of sunlight exposure (e.g., number of hours of direct sunlight per day greater than or equal to a specified operational limit), being less than or equal to a maximum allowable irradiance level, or falling within a specified percentage range around a target solar insolation value, depending on the operational requirements defined for the solar power plant.

The one or more processors can be configured to determine, based on at least a subset of the predicted variables, forecast of precipitation in a geographical area during the second time interval. The one or more processors can be configured to identify, based on the forecast of precipitation, a location within the geographical area in which the precipitation satisfies a constraint for an agricultural farm. For example, a constraint for an agricultural farm can specify a minimum or maximum amount of precipitation desired for a given type of crop or irrigation planning at a particular location. The system can identify locations where the predicted precipitation meets such predefined agricultural precipitation thresholds, thereby determining that the precipitation satisfies a constraint for the agricultural farm in a given location or area.

An aspect of the technical solutions is directed to a method. The method can include identifying, by one or more processors coupled with memory, a dataset comprising variables indicative of characteristics of weather during a first time interval. The method can include determining, by the one or more processors, based on the dataset, parameters of marginal distributions of the variables using a first function for maximum likelihood estimation and a second function for probability weighted moment matching of the parameters. The method can include constructing, by the one or more processors, based on the variables, a correlation matrix configured for parallel processing. The method can include generating, by the one or more processors, via parallel processing by the one or more processors and based on the correlation matrix, predicted sample of variables for a weather forecast indicating the characteristics of weather during a second time interval. The method can include providing, by the one or more processors, for display, the predicted sample of variables for the weather forecast via a user interface.

The dataset can include historical weather data collected from a meteorological station and the characteristics of weather correspond to at least one of: pressure, temperature, saturation vapor pressure, vapor pressure deficit, specific humidity, air density, cloud coverage, and wind speed. The distribution can include a Johnson SU probability distribution and the first function for maximum likelihood estimation can be implemented using a gradient-based adjustment of the parameters.

The method can include implementing, by the one or more processors, the gradient-based adjustment using at least one of a function for Broyden-Fletcher-Goldfarb-Shanno (BFGS) operation or a function for Levenberg-Marquardt operation. The method can include using, by the one or more processors, a Hessian matrix to iteratively refine the parameters using at least one second-order computation. The method can include normalizing, by the one or more processors, the probability distributions. The method can include constructing, by the one or more processors, the correlation matrix based on the variables of the dataset.

An aspect of the technical solutions is directed to a non-transitory computer-readable medium storing processor-executable instructions. The instructions, when executed by one or more processors, can cause the one or more processors to identify a dataset comprising variables indicative of characteristics of weather during a first time interval. The instructions, when executed by one or more processors, can cause the one or more processors to determine, based on the dataset, parameters of marginal distributions of the variables using a first function for maximum likelihood estimation and a second function for probability weighted moment matching of the parameters. The instructions, when executed by one or more processors, can cause the one or more processors to construct, based on the variables, a correlation matrix configured for parallel processing. The instructions, when executed by one or more processors, can cause the one or more processors to generate, via parallel processing by the one or more processors and based on the correlation matrix, predicted sample of variables for a weather forecast indicating the characteristics of weather during a second time interval. The instructions, when executed by one or more processors, can cause the one or more processors to provide, for display, the predicted sample of variables for the weather forecast via a user interface.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram of an example system for providing a long-term weather forecasting framework using statistical and machine learning modeling.

FIG. 2 is a block diagram of an example system for providing weather forecast parallel processing via statistical transformation modeling using Nataf transformation.

FIG. 3 illustrates an example flow chart of a method for providing a compute efficient adjusted Nataf transformation for a long-term weather forecast, in accordance with embodiments described herein.

FIG. 4 illustrates an example flow chart of a method for providing a long-term weather forecasting framework using statistical machine learning modeling, in accordance with embodiments described herein.

FIG. 5 is a block diagram of an example computing system an architecture that can be employed to implement elements of the systems and methods described and illustrated herein.

FIG. 6 illustrates a pair of plots of weather data in an original space and a transformed space, in accordance with embodiments described herein.

FIG. 7 illustrates an example plot of observed data and the samples generated based on the same data, in accordance with embodiments described herein.

### DETAILED DESCRIPTION

Following below are more detailed descriptions of various concepts related to, and implementations of, methods, apparatuses, and systems for a long-term weather forecasting framework using statistical and machine learning modeling. The various concepts introduced above and discussed in greater detail below may be implemented in any of numerous ways.

It can be a challenge for weather forecasting systems to generate reliable long-term weather predictions over large geographical areas while maintaining high resolution and accuracy and conserving computational resources. While machine learning can be used to facilitate the process, it can be difficult for weather forecasting models to maintain their computational efficiency while avoiding the risk of unrealistic predictions (e.g., model hallucinations) and capturing complex, multivariate relationships in atmospheric data. Moreover, weather forecasting models utilizing machine learning can experience hallucinations due to the inability to constrain variables within their realistic bounds, leading to inaccurate predictions of nonexistent patterns. These limitations can undermine the reliability of extended weather forecasts, limiting their usefulness for different applications, while also consuming substantial computational resources.

The technical solutions of this disclosure can overcome these challenges by combining a Non-parametric Joint Distribution Model (NJDM) utilizing a Nataf transformation to process constraint-bound high-dimensional data with a diffusion-based deep learning model. The diffusion-based deep learning moder can be trained to reintroduce fine-grained details to the NJDM outputs. The resulting output can provide high-resolution, large-area and long-term weather forecasts reducing the risk of unrealistic model predictions (e.g., hallucinations) while completing the processing in a fraction of time and while consuming a fraction of the computational resources compared to other ML based systems. Predictions can be long-term predictions, such as forecasts for 30, 60, 90, 180, or 365 or more days into the future, can be high-resolution predictions over geographic grids finer than 5 kilometers between forecast points, and can cover large areas, such as regions extending over 500 km² to continental-scale forecasts of more than 1,000,000 km².

NJDM can be used to process high-dimensional multivariate distributions for representing complex weather patterns using a Nataf transformation for modeling and sampling of such distributions. For instance, a Nataf transformation can be utilized for modeling complex, multivariate distributions in real-world phenomena, such as Monte Carlo simulations for fields like weather forecasting, financial risk assessment, and engineering. The Nataf transformation can be implemented using high-dimensional multivariate dataset samples, which in the context of weather prediction, can include parameters such as temperature, 500 millibar height, wind components, humidity, and total column water vapor. This technique can be used for transformations of correlated random variables with arbitrary marginal distributions into independent standard normal variables, capturing intricate dependencies used to determine the predictions and risk estimations.

Due to performance limitations of processors, such as graphical processing units (GPUs) used for processing of models with high-dimensional datasets, it can be challenging for solutions with such datasets to achieve accurate and reliable results. The issues can arise from insufficient GPU acceleration or throughput and inefficient algorithms, which can slow down computations of such models for large-scale problems. For instance, different solutions can have limited support for non-standard distributions, restricting the ability of such solutions to accurately model the complex, asymmetric, and heavy-tailed phenomena frequently observed in real-world datasets.

Correlation transforms, such as the one used in the Nataf method, can be particularly computationally intensive when dealing with more sophisticated distribution types. Such high computational demands can constrain the Nataf method's applicability in high-fidelity modeling of complex high-dimensional distributions, resulting in increased desire for a more efficient and flexible approach to multivariate distribution modeling and sampling.

The technical solution introduces improvements and adjustments to the Nataf transformations, including using Johnson SU parameters to estimate marginal distributions, adjusting correlations through numerical root-finding using the bisection method, and implementing positive definiteness of correlation matrices through eigendecomposition, eigenvalue adjustment, and matrix reconstruction, all of which contribute to improved computational efficiency and performance in the weather forecasting model. Combining this NJDM with such an improved Nataf technique to predict weather trends with a diffusion-based deep learning model trained to provide additional variations for such trends, results in a weather forecasting model that is both accurate and reliable and computational resource and energy efficient.

The weather forecasting techniques of the solutions provided herein can provide several benefits in various fields and applications. For instance, in the field of agriculture, more accurate long-term forecasts can aid in crop planning, irrigation scheduling, and pest management. For instance, in the energy sector, improved predictions of solar exposure, temperature or wind patterns can help in forecasting energy demand and optimizing renewable energy installations. For instance, in applications, such as disaster preparedness, the technical solution's ability to provide high-resolution forecasts over large areas can facilitate early warning systems and resource allocation.

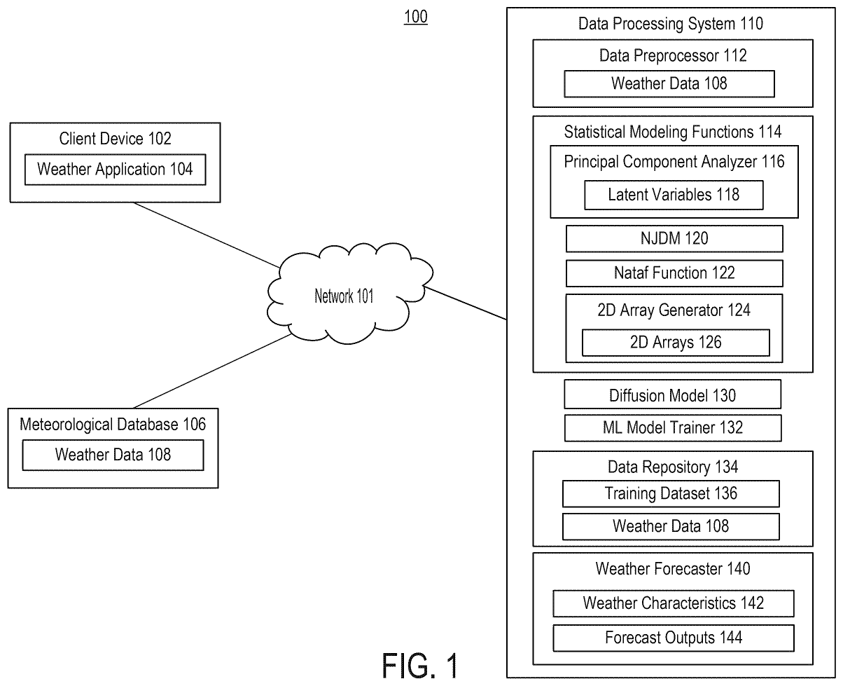

FIG. 1 depicts an example system 100 for providing a long-term weather forecasting framework using statistical and machine learning modeling. The example system 100 can include one or more client devices 102, one or more meteorological databases 106 and one or more data processing systems 110 communicating with each other, via one or more networks 101. The client device 102 can execute a weather application 104 for accessing the functionalities of the data processing system 110. The meteorological database 106 can store and provide access to various weather data 108 that can be used by the data processing system 110. The data processing system 110 can utilize the weather data 108 of the meteorological database 106 along with its various functionalities to provide a weather forecasting model using statistical and machine learning functionalities.

The data processing system 110 can include one or more of data preprocessors 112, statistical modeling functions 114, diffusion models 130, ML model trainers 132, data repositories 134 and weather forecasters 140. Data preprocessor 112 can include any functionalities for preprocessing (e.g., cleaning, organizing and transforming) the weather data 108 to facilitate modeling. Statistical modeling function 114 can include one or more of Non-parametric Joint Distribution models 120 (also referred to as the NJDMs 120), Nataf functions 122, 2D array generators 124 and principal component analyzers 116 for generating latent variables 118. Data repository 134 can store and provide for access one or more training datasets 136 and weather data 108. Weather forecaster 140 can include any functionality for determining and generating weather characteristics 142 and forecast outputs 144.

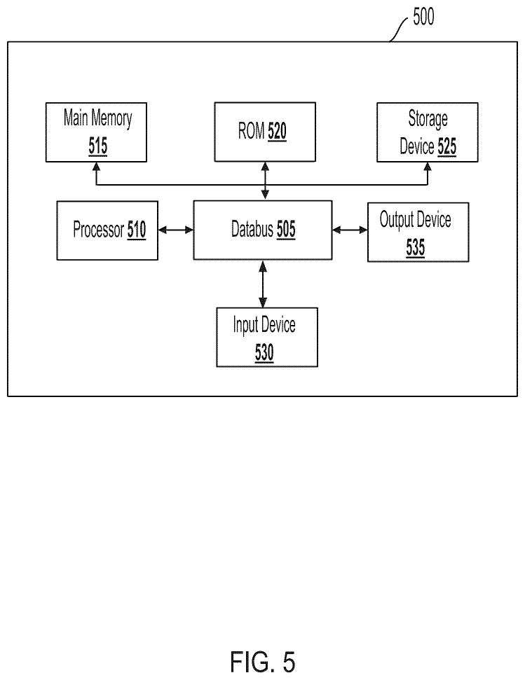

Client device 102 can include any computing device that allows users to interact with the weather forecasting system implemented on the data processing system 110. Client device 102 can include any type of a computing device operating or including any computing system, such as computing system 500 of FIG. 5. Client device 102 can include any personal computer, smartphone, tablet or a laptop allowing a user to operate a weather application 104 to request a weather forecast or a prediction. For example, a client device 102 can be a smartphone a user can utilize to access a weather application 104 to request a customized or personalized weather forecast for a particular geographical area, location or a region, providing particular inputs of weather characteristics in which the user is interested.

Weather application 104 can include any software application configured or designed to facilitate access to weather forecasts, such as those generated using the functionalities of the data processing system 110. Weather application 104 can include or provide features such as interactive weather maps, forecast visualizations, simulations or imagery along with any alerts for particular weather characteristics or conditions (e.g., extreme weather alerts). Weather application 104 can include a graphical user interface (GUI) which can be utilized by a user of the application to enter application parameters. Application parameters can include any particular geographical area or a region of interest or a particular location in which the user is interest. Application parameters can include any weather characteristics, such as temperature, humidity, wind, sunny or cloudy weather or any other weather related information. Weather application 104 can include user interface (UI) allowing a user to enter weather characteristics for which a customized forecast output 144 can be generated. For instance, the weather application 104 can include a UI allowing the user of the application to specify weather conditions or characteristics of interest, such as the number of days or hours of sunny weather in a particular geographical area or a location, an amount of wind or airflow through a particular location or area, an amount of precipitation, temperature patterns or any other weather related data.

Meteorological database 106 can include any structured repository (e.g., a storage device 525 of FIG. 5) that can be configured or designed to store and provide access to various data, such as weather data 108. Meteorological database 106 can be accessible to the data processing system 110 or the weather application 104 of the client device 102 via an internet connection (e.g., network 101). Meteorological database 106 can include data structures and databases for storing various historical weather data or records, including any wind, temperature, humidity, solar radiation data (e.g., hours or days of sunny or cloudy weather in a location). Meteorological database 106 can include satellite imagery or real-time meteorological observations from various sources. For example, meteorological database 106 can store and provide access to various temperature readings from different locations, humidity levels over time, or wind speed data collected from weather stations.

Weather data 108 can include any data on weather including any quantitative information regarding atmospheric conditions that can be used for weather forecasting. Weather data 108 can include or indicate any type and form of weather characteristics, such as data on wind, humidity, precipitation, solar radiation, cloud movements, temperature variations, atmospheric pressure, visibility, dew point, and snow accumulation. For instance, weather data 108 can include or provide hourly wind speed and direction measurements, daily humidity levels as percentages, or total rainfall amounts over a specified period, solar radiation data indicating the total hours of sunlight received, cloud cover percentages to assess the extent of overcast conditions, or temperature extremes recorded over days, weeks, months or years. Weather data 108 can include, for example, daily maximum and minimum temperatures for a month, daily wind movements, directions and speed, hourly rainfall amounts during any storm events, or average wind speeds recorded over a time period.

Client devices 102 and data processing system 110 can exchange information as well as access weather data 108 on a meteorological database 106 via a network 101. The network 101 can include any communication infrastructure that facilitates the interaction between various devices (e.g., client devices, meteorological databases, and data processing systems) in the weather forecasting framework or environment, such as the system 100. Network 101 can include wired or wireless connections or networks, facilitating seamless data exchange and access to weather information across various components of the system 100. For example, network 101 can include internet connections that allow client devices to access cloud-based applications, local area networks (LANs) connecting on-premises data processing systems, or even wide area networks (WANs) that link multiple geographical locations for comprehensive data sharing and collaboration. Network 101 can include or utilize any wireless network functionalities, such as Wi-Fi technology, cellular networks, Bluetooth, coaxial or fiberoptic networks or connections or any other technologies for facilitating network communications and data exchange.

Data processing system 110 can include any combination of hardware and software configured for forecasting data using modeling. Data processing system 110 can include computational framework that processes weather data to generate forecasts based on a combination of one or more statistical and machine learning (ML) models, along with any types of statistical functions or functionalities. Data processing system 110 can include any combine or include various weather forecasting functions and models, such as statistical modeling functions 114 with an NJDM 120, a Nataf function 122 and a principal component analyzer 116, diffusion models 130, and weather forecasters 140. Data processing system 110 can be implemented on a computing environment, such as the one provided by a computing system 500 of FIG. 5. Data processing system 110 can be implemented or provided on one or more virtual machines or a cloud-based system, such as a software as a service operating on one or more servers, a software as a product or a software as a platform. Data processing system 110 can utilize the functionalities of the data processing system to analyze meteorological data and produce predictive outputs. For example, it can utilize statistical methods to identify trends in historical data or apply ML techniques to improve forecast accuracy by identifying temporal variations or changes within such trends (e.g., fine-grained details to include in the weather forecast output).

Data preprocessor 112 can include any combination of hardware and software for preprocessing, filtering or reformatting weather data 108. Data preprocessor 112 can include functionalities designed to prepare raw weather data 108 received from the meteorological database 106 for particular modeling purposes. For instance, data preprocessor 112 can include the functionalities to reformat or rearrange the weather data 108 according to the preferences, settings or demands of any of the data processing system 110 functionalities, including statistical modeling functions 114 (e.g., NJDM 120, Nataf function 122) or ML models, such as the diffusion model 130. The preprocessing can include cleaning the data by removing outliers or filling in missing values and transforming the data into a suitable format for analysis. For instance, the data preprocessor 112 can normalize temperature readings across different units or aggregate hourly data into daily averages, to accommodate particular types of inputs into various functions or models of the data processing system 110.

Statistical modeling functions 114 can include any statistical or computation functions, processes or operations for analyzing the weather data 108. Statistical modeling functions 114 can include the functionalities for processing data (e.g., preprocessed or reformatted weather data 108) in order to process various meteorological functions or models. Such functions can include various statistical computations or determinations, such as various statistical moments (e.g., mean, median, mode, variance, standard deviation or any other statistical determination). Statistical modeling functions 114 can include or implement probability functions, such as probability distribution curves of random variables, any regression analyses or time series forecasting. For example, statistical modeling functions 114 can utilize a non-parametric joint distribution model 120 to process high-dimensional multivariate weather data along with Nataf transformations that can be adjusted using Johnson SU functions or other statistical operations or functions. Such operations can be used to determine latent variables 118, generate 2D array outputs from 2D array generators 124 or predict any weather characteristics, such as solar radiations, precipitations, wind directions or velocities or temperatures based on historical trends or modelled likelihoods.

Principal component analyzer 116 can include any technique (e.g., principal component analysis) that can be applied to reduce the number of input variables from a dataset, while preserving specific information about the dataset. For example, the principal component analyzer 116 can be utilized along with or within the NJDM 120 to reduce high-dimensional weather data 108 into a manageable number of latent variables 118, to facilitate a more efficient analysis and computational efficiency. For example, the NJDM 120 can utilize the principal component analyzer 116 to apply sparse PCA to transform datasets originally represented as two-dimensional images (e.g., 600×500 pixels) into a reduced set of latent variables, such as 10 or 15 variables. This transformation can effectively condense or reduce hundreds of thousands of parameters into a more digestible format that can be processed with a fraction of computational resources (e.g., GPUs) speeding up the processing and reducing computational resources utilized. For instance, by reducing a dataset with 300,000 parameters to just 10 latent variables, the principal component analyzer 116 can facilitate quicker computations and enhance the model's ability to focus on the features that influence weather patterns.

Latent variables 118 can include any underlying factors derived from high-dimensional weather data 108 that represent specific or target weather characteristics of the observed phenomena. Latent variables 118 can serve as simplified representations of complex meteorological patterns that can be used in predictive modeling. Latent variables 118 can be utilized within the NJDM 120 to simplify complex weather data by capturing the most significant underlying patterns and relationships among multiple atmospheric parameters. For instance, the NJDM can reduce a high-dimensional dataset, originally including hundreds of thousands of parameters, into a smaller set of latent variables 118 (e.g., as few as 5, 10, 15 or 20 variables) while still maintaining the information about the weather phenomena being studied. Latent variables 118 an represent individual weather characteristics or underlying patterns and relationships between such characteristics, such as: temperature, humidity, solar radiation, precipitation, and wind speed, any of which can be correspond to any given elevation or location. This reduction in the number of variables used can improve the computational efficiency while facilitating easier interpretation of the data, allowing the models to focus on the factors influencing the weather patterns without being overwhelmed by extraneous details. By using techniques, such as the sparse PCA, the NJDM 120 can condense the extensive weather data 108 into the latent variables 118, serving as inputs for further modeling and forecasting processes.

Non-parametric Joint Distribution Model 120, also referred to as NJDM or NJD model 120, can include any statistical framework (e.g., a structured approach with series of statistical determinations) for representing or analyzing complex, high-dimensional multivariate distributions. The high-dimensional distributions can include probability distribution curves for a large number of features or variables (e.g., weather characteristics). The multivariate nature of such distributions can pertain to the datasets that involve multiple variables or dimensions, allowing for the analysis of relationships and dependencies between different parameters within the data. NJDM 120 can be configured or designed to represent and analyze complex, high-dimensional multivariate distributions in weather data 108. The NJDM 120 weather forecasting, by utilizing techniques such as the Nataf function 122 to capture intricate dependencies among multiple variables without assuming specific parametric forms.

NJDM 120 can be configured to generate various statistical moments for weather data 108 and process high-dimensional multivariate probability distributions for such characteristics or their variables. NJDM 120 can be configured to utilize the distributions to capture or represent, based on the weather data 108, various weather characteristics (e.g., patterns) through the use of a Nataf function 122 for modeling and sampling. NJDM 120 can generate long-term weather forecasts by producing consistent predictions for extended periods, such as 35, 50, 60, 90, 120 or 365 days. Such determinations can utilize, or be based on, principal component analysis (PCA) implemented using the principal component analyzer 116 to reduce dimensionality and simplify the multi-dimensional weather data 108 into a manageable number of latent variables 118. For example, the NJDM 120 can include the functionalities for providing or utilizing constraints on the probabilities, maintaining accuracy and reducing the risk of unrealistic outputs (e.g., model hallucinations) improving the reliability of the weather forecast outputs 144. For instance, the NJDM 120 can utilize fixed marginal distributions derived from historical data to constrain outputs, ensuring that predictions that remain within realistic bounds and improving overall forecast reliability. The NJDM can produce a series of 2D images representing weather parameters, which can serve as inputs for subsequent models, allowing for high-resolution predictions while maintaining overall consistency in long-term forecasts.

Nataf function 122 can include any function for performing a transformation that converts a vector of dependent random variables with specified marginal distributions and a correlation structure into a set of independent standard normal variables. The Nataf function 122 can implement a transformation mapping a random vector with a specific joint distribution into a standard space where components are uncorrelated and follow a standard normal distribution, preserving the probabilistic properties of the original variables (e.g., isoprobabilistic transformation). Nataf function 122 can be used for, or facilitate use of, statistical analysis and simulations in various applications. Nataf function 122 can be used for statistical analysis of data variables or parameters with the NJDM 120 to convert correlated random variables into independent standard normal variables. For instance, the Nataf function 122 can be applied to transform the data corresponding to the temperature, solar radiation and pressure readings into variables that can be analyzed statistically using other functions without losing the relations or dependencies between the variables.

The Nataf function 122 can implement several functionalities, including the ability to handle marginal distributions and correlation structures through an isoprobabilistic mapping. For instance, the Nataf function 122 can transform a multivariate distribution characterized by its marginal cumulative density functions and copula into a standard normal space, where the relationships between the variables are simplified. Such a transformation can simplify the processing of complex datasets, allowing for simpler statistical analysis. For example, the Nataf function can allow for the assessment of failure probabilities by transforming input uncertainties into a format that is more manageable for computational modeling, which can reduce computational resources, speed up the processing and conserve system energy.

The Nataf function 122 can be used to generate samples from correlated random variables after establishing their underlying distributions. For example, by applying techniques such as Cholesky decomposition, the Nataf function 122 can facilitate the generation of the samples in a way that preserves the specified correlations among the data variables. This capability can allow for accurate and reliable weather forecasting as the understanding the joint behavior of multiple random variables can improve the accuracy of the weather determinations.

2D array generator 124 can include any mechanism for creating two-dimensional representations of meteorological parameters over a geographical area. 2D array generator 124 can produce 2D arrays 126. 2D array generator 124 can include the functionalities to utilize ML or statistical models to generate 2D arrays, such as Nataf functions 122 or ML models trained to generate 2D arrays of smoothed or averaged patterns based on the latent variables 118. The generated 2D arrays 126 can include 2D images or 2D representations of weather characteristics generated from the latent variables 118 and used to provide generalized, averaged or smoothed patterns or trends of weather characteristics across a defined region. For instance, 2D array generator 124 can create a 2D array 126 providing a grid of temperature variations across a state or region at a specific time. The 2D array generator 124 can be utilized to create 2D arrays that can be representations of weather characteristics, such as temperature, solar radiation, humidity, and precipitation, allowing for a clear understanding of spatial distributions and trends. For instance, 2D array generator 124 can produce 2D arrays 126 that can include images sized at 600×500 pixels to represent temperature variations across a region, based on weather data 108. 2D array generator 124 can create 2D arrays providing visualizations for variables or parameters, such as wind speed and direction, indicating how these weather characteristics trend or change across different locations. The 2D arrays 126 generated can serve as inputs for further processing in models, such as the NJDM 120 or the diffusion model 130, which may then refine these outputs to enhance resolution and detail in long-term weather forecasts.

2D arrays 126 output from the 2D array generator can be blurry or low-resolution 2D images of the weather characteristics in a geographical area. 2D arrays 126 can be constructed from the latent variables 118 (e.g., reduced data set). As the sparce PCA of the principal component analyzer 116 can capture a select group of most relevant features of the weather data 108, while reducing some of the details via dimensionality reduction to the latent variables 118, the resulting 2D arrays 126 can include averaged or smoothed representations of the original high-resolution weather data 108. These 2D arrays 126 providing blurry, low resolution or averaged detail data of the region can serve as a base for additional detailed features that can be input by the subsequent diffusion model 130, providing a foundation of overall weather patterns while allowing the diffusion model to reintroduce fine-grained details.

Diffusion model 130 can include any machine learning model configured to add fine-grained details to initial forecasts generated by other models. For instance, diffusion model 130 can include any diffusion-based deep learning model trained on weather data to utilize 2D array outputs from the 2D array generator 124 of the NJDM 120 or any other statistical model function 114 to add additional weather characteristics related information and provide a refined forecast output 144. Diffusion model 130 can be configured to add details to, or refine the resolution of, the low-resolution outputs from earlier processing stages into high-resolution predictions, such as 2D array 126 outputs from the 2D array generator 124. Diffusion model 130 can generate, as its outputs, finalized 2D images (e.g., forecast outputs 144) providing general trends and refined variations or localized changes to the patterns to add to the 2D arrays 126. The diffusion model 130 can be operated and utilized by the weather forecaster 140, which can initiate the diffusion model 130, providing the inputs, such as the 2D arrays 126, recent weather observations (e.g., weather data 108) to generate the forecast outputs 144 (e.g., 2D images with average and refined weather characteristic patterns and trends).

The diffusion model 130 can be configured to improve the resolutions of predictions of statistical models (e.g., NJDM 120) by variations to the trends or additional more refined weather change patterns to the output generated by such models (e.g., 2D array 126). The diffusion model 130 can leverage deep learning techniques, specifically trained on historical weather data, to improve the accuracy and reliability of forecasts. The training process for the diffusion model 130 can involve using the historical data (e.g., prior one or more days, one or more weeks or one or more months of weather information) to learn to predict detailed variations on the 2D arrays 126 provided by the statistical modeling functions 114. By applying an autoregressive approach during training, the diffusion model 130 can effectively add these fine details (e.g., variations in the general trends) to the statistical modeling functions outputs, resulting in high-resolution predictions for intended weather characteristics, such as the temperature, wind components, and total column water vapor.

The diffusion model 130 can generate fine-grained details by enhancing the blurry, averaged outputs from the NJDM 120 and other statistical modeling functions 114 using deep learning approach. The fine-grained details generated by the diffusion model 130 can include or represent localized variations and changes to general trends indicated by the averaged 2D arrays 126. These details can include or correspond to specific phenomena such as sudden temperature spikes, localized precipitation events, or shifts in wind patterns that are not discernible in the smoothed representations. For instance, while the statistical modeling functions 114 can produce a blurred 2D array 126 showing an overall trend of increasing temperature across a region, the diffusion model 130 can refine this output to reveal specific areas experiencing heat waves or cold fronts, as well as wind changes or precipitation areas, thus providing a more nuanced understanding of the weather dynamics. The generation of these details by the diffusion model 130 can occur through a training process that utilizes historical weather data 108, where the model can learn to associate patterns in the blurry images with corresponding high-resolution observations, based on any recent input weather data from that region (e.g., weather data 108 corresponding to the most recent 12, 24 or 48 hours in the area). By applying an autoregressive method during such training, the diffusion model 130 can iteratively improve its predictions, effectively reconstructing the finer aspects of weather patterns while maintaining computational efficiency.

As an example, statistical modeling functions 114 (e.g., NJDM 120, Nataf function 122, 2D array generator 124 and principal component analyzer 116) can be configured to perform various operations. For instance, the principal component analyzer 116 can reduce the dimensionality (e.g., number of variables or parameters) of the processed data by applying a sparse PCA. The sparse PCA can take the high-dimensional weather data 108, originally represented as two-dimensional (2D) images of XY pixel images of any size (e.g., 500×350, 600×500, 800×600 or 1000×800) and reduce it down to a manageable number of latent variables (e.g., 5, 10, 15, 20 or 25 variables) that can represent the relevant characteristics and relations of the data. For example, using the PCA function, a set of 600×500 variables (e.g., 300,000 variables in total) can be represented by only a small set (e.g., 10-15) latent variables 118. This can reduce the computational complexity of the data, while capturing the most important variations in the data, and providing a smooth or averaged representation of the original high-resolution images (e.g., via 2D array generator 124).

The statistical modeling functions 114 can utilize the NJDM 120 to determine fixed marginal distributions and correlations directly from historical weather data 108. This approach can help constrain outputs, such as temperature and 500 millibar height, to a range of expected and realistic values (e.g., based on the historical data), thereby improving the accuracy of the solution and reducing the risk of model hallucinations. Based on the outputs of the statistical modeling functions 114 (e.g., 2D arrays from the 2D array generator 124), the weather forecaster 140 can utilize diffusion model 130 to generate predictions for an extended number of days, such as 20, 25, 30, 35, 40, 45, 60, 100 or more than 100 days. Due to the reduction of dimensionality and use of latent variables 118, the computation of the forecast output 144 can be implemented simultaneously and with reduced computational resources.

The diffusion-based deep learning model can complement the 2D array 126 that are output from the 2D array generator 124 by adding fine-grained details to their averaged or blurry images. This combination of the statistical modeling functionality (e.g., NJDM with Nataf) and the diffusion model 130 can allow for high-resolution predictions (e.g., provided by the diffusion model) while maintaining the overall consistency (e.g., provided by the NJDM). For instance, the diffusion model 130 can receive two categories of inputs: 2D inputs from the NJDM (blurry images of weather parameters) and 3D atmospheric data at multiple pressure levels (e.g., at 925 to 500 millibars), including total column water vapor, U and V components of wind, temperature, and geopotential height. Based on these inputs, the diffusion model 130 can generate high-resolution predictions for multiple weather parameters, such as temperature, wind components, geopotential height, and total column water vapor. By focusing on these parameters, the model can maintain computational efficiency while still providing comprehensive predictions.

ML model trainer 132 can include any system configured for training ML models, such as diffusion model 130. ML model trainer 132 can utilize training datasets 136 with various meteorological data, including for example raw or processed (e.g., preprocessed) historical weather data 108 and other relevant inputs to train the diffusion model 130. The ML model trainer 132 can utilize the training datasets 136 to train the diffusion model 130 to generate and provide, for the 2D arrays of the 2D array generator 124, various refined weather characteristics patterns (e.g., variations in weather trends) to include into the forecast outputs 144. The ML model trainer 132 can employ various algorithms to optimize model performance based on training datasets. For instance, the ML model trainer 132 can use supervised learning techniques to improve the accuracy of predictions by adjusting model parameters based on past observations.

The training process utilized by the ML model trainer 132 for the diffusion model 130 can involve historical weather data 108, using the previous 12, 24, 48, 72 or more hours of weather information to predict details. This training set can be created from the 2D blurry images of the NJDM and corresponding high-resolution historical data. By applying an autoregressive approach, the diffusion model 130 can generate fine grained details (e.g., weather changes in short time intervals) to add the fine-grained details to the NJDM outputs, improving the resolution and accuracy of the predictions.

Data repository 134 can include any storage solution that stores and provides access to the data. The data repository 134 can include hard drives or hard disc storage devices (e.g., 525 of FIG. 5) or any other memory storage for storing training datasets 136 and processed weather data 108 for easy access by the data processing system. The data repository 134 can validate that relevant datasets are readily available for analysis and modeling tasks. For example, the data repository 134 can store historical temperature records alongside current meteorological observations, each of which can be used by the data processing system functionalities (e.g., diffusion model 130 or statistical modeling functions 114).

Training dataset 136 can include any collection of historical weather data 108 or historical weather records, analyses or data used to teach machine learning models how to make accurate predictions based on past patterns. Training dataset 136 can include 2D arrays 126 along with the historical weather data 108 (e.g., data from prior months or years for a given geographical area) as well as most recent weather observations (e.g., data within the past 24, 48 or 72 hours) for the same geographical area. Training datasets 136 can include labeled examples that allow models being trained (e.g., diffusion model 130) to learn relationships between input features and target outputs. For instance, training dataset 136 can include daily temperature highs and lows paired with corresponding atmospheric conditions over several days, weeks, months or years, allowing the diffusion model 130 to infer relations based on the data.

Weather forecaster 140 can include any combination of hardware and software that utilizes statistical modeling functions 114 and diffusion model 130 to generate forecast outputs 144. Weather forecaster 140 can include any functionality within the system dedicated to generating specific weather predictions based on processed data inputs. Weather forecaster 140 can synthesize information from various statistical modeling functions 114 and deep learning models (e.g., diffusion model 130) to produce two-dimensional representations of the weather characteristics 142 within a detailed forecast (e.g., forecast output 144) for a given geographical area. For example, the weather forecaster 140 can generate daily summaries of expected temperatures and precipitation levels or issue alerts for severe weather events based on predicted conditions.

The weather forecaster 140 can generate weather forecast outputs 144 by synthesizing data from various statistical modeling functions 114 and deep learning models (e.g., diffusion model 130). The weather forecaster 140 can generate forecast outputs 144 providing two-dimensional representations of daily weather conditions for a series of 30, 35, 40, 50, 60, 90, 120, 365 days or multiple years. The weather forecaster 140 can generate forecast outputs 144 for any time intervals and any weather characteristics, such as temperature, humidity, wind speed and direction, precipitation levels, total column water vapor, geopotential height, and atmospheric pressure, as well as severe weather alerts for events such as storms, hurricanes, and heatwaves. The weather forecaster 140 can generate hourly updates on wind speeds and directions, which can be used in aviation and maritime operations, or provide localized forecasts for agricultural applications, such as frost warnings or heat advisories tailored to specific crops.

Weather characteristics 142 can include any specific attributes related to atmospheric conditions that are predicted by the forecasting system. The weather characteristics can include any weather feature or characteristic represented by the forecast output 144, including for example temperature, humidity, wind speed and direction, precipitation levels, total column water vapor, geopotential height, solar radiation, cloud movements and characteristics and atmospheric pressure. Weather characteristics 142 can correspond to or include weather alerts for events such as storms, hurricanes, and heatwaves. These weather characteristics 142 can include variables or parameters such as expected temperature ranges, likelihoods of precipitation events, or wind speeds over a given time period. For instance, the weather characteristics can include detailed anticipated highs and lows for an upcoming week or forecast potential storm paths based on current meteorological patterns.

Forecast outputs 144 can include any final predictions generated by the system regarding future weather conditions within specified geographical areas and timeframes. Forecast outputs 144 can include two-dimensional representations of any one or more weather characteristics 142. Forecast outputs 144 can take the form of visualizations such as maps or graphs depicting expected weather characteristics, such as wind directions and velocities, solar radiation or exposure, cloud coverage, precipitation locations, levels and types (e.g., snow or rain), or any other meteorological or atmospheric phenomena forecasted or predicted over a time interval. Forecast outputs 144 can include 2D representations generated using 2D arrays 126 corrected, adjusted or modified using ML modeling, such as diffusion model 130 providing short time or refined changes to the general patterns or trends. For instance, forecast output 144 can include projected rainfall distribution across regions for the next month or highlight areas at risk for severe storms based on predictive analytics.

The forecast outputs 144 can achieve improved performance over large geographical areas (e.g., approximately 1000 kilometers), making the forecast outputs 144 suitable for continental-scale predictions. By constraining the forecast outputs 144 through the statistical modeling functions 114 (e.g., NJDM and Nataf) and the corresponding fixed marginal distributions, the weather forecaster 140 can reduce the risk of hallucination or unrealistic predictions that can plague purely deep learning-based approaches. The combination of dimensionality reduction in the NJDM and the focused parameter set in the diffusion model can allow for efficient processing, potentially requiring less computational resources than traditional weather prediction models of similar scope.

The flexibility of the system's architecture can allow for potential use of other generative frameworks in place of the diffusion model 130 or other statistical modeling functions 114 instead of the ones described herein as examples. The system can be designed to accommodate various types of weather data and can potentially be adapted to different geographical regions or climate zones with appropriate training data.

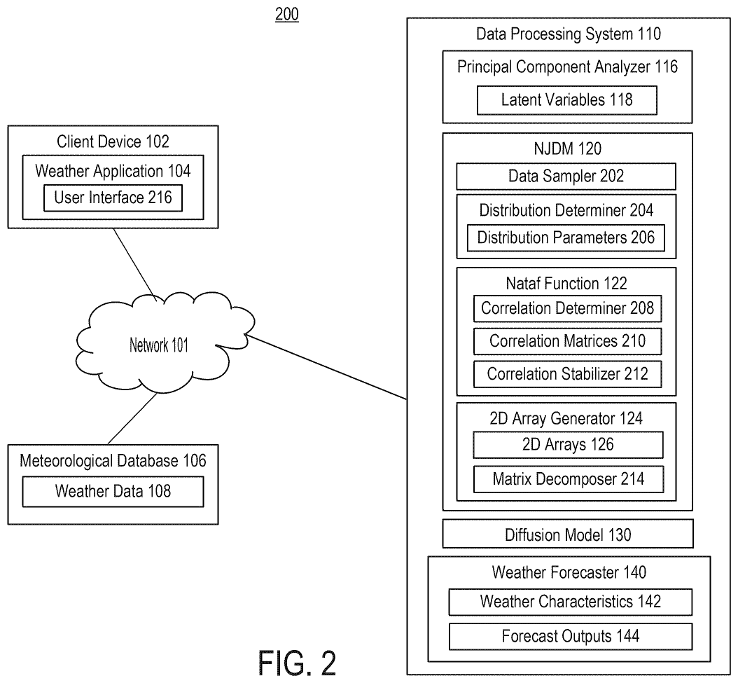

FIG. 2 illustrates an example system 200 for providing weather forecast parallel processing via statistical transformation modeling using Nataf transformation. The example system 200 can include the same configurations or similar configurations and features as presented in example system 100 of FIG. 1 and vice versa. The system 200 can include a data processing system 110 that can include one or more of principal component analyzers 116, NJDMs 120, diffusion models 130 and weather forecasters 140, including the features and functionalities as described in connection with example system 100 of FIG. 1. For instance, NJDM 120 can provide statistical modeling functionality for generating 2D arrays 126 and latent variables 118 that can be input into the diffusion model 130 per inputs or instructions by a weather forecaster 140 to generate forecast outputs 144 corresponding to one or more weather characteristics 142.

The NJDM 120 can include one or more of data samplers 202 for obtaining samples from multivariate distributions providing information about marginal distributions of each of the variables in the weather data 108 and their correlations. The NJDM 120 can include one or more distribution determiners 204 for determining or estimating the marginal distributions for the variables and determining distribution parameters 206 (e.g., location and scale parameters or probability-weighted moments or PWMs). The NJDM 120 can include one or more Nataf functions 122 for applying forward Nataf transformation to transform each of the marginal distributions to standard normal distributions. The NJDM 120 can include one or more correlation determiners 208 for generating and processing one or more correlation matrices 210 which can be adjusted to match original correlation structures. The NJDM 120 can include one or more correlation stabilizers 212 for implementing positive definiteness (e.g., symmetrize the matrix, compute eigendecomposition, modify eigenvalues and reconstructs the matrix to provide positive definiteness). The NJDM 120 can utilize the 2D array generator to implement sample generation via Cholesky decomposition to generate the samples and apply inverse Nataf transform to map the samples to the original space, preserving intended marginal distributions and correlations.

Example system 200 can be directed to a hybrid diffusion approach involving a probabilistically calibrated ensemble forecast system for long range weather forecasts. The hybrid diffusion can include a data-driven forecast technique combining a deep learning model with a Nataf joint distribution model (NJDM) to produce realistic large-scale weather patterns using a diffusion based deep learning model. This approach can correct dynamical model probabilistic biases and climate drift that can be present in other models, by directly modeling the joint distribution of dynamical model predictions and observed surface weather.

The example system 200 can utilize the NJDM 120 to provide realistic sampling of the joint distribution using marginal distributions that are fixed and estimated from observational weather data. The NJDM technique can be used to forecast weather for long term (e.g., over 15,30, 60, 90, 365 or more days) and over large geographical areas (e.g., thousands of square kilometers). The example system 200 can overcome computational challenges involving the large number of variables to be computed or simulated in NJDM modeling, by applying dimensionality reduction (e.g., reduction in the number of variables to compute using sparse PCA) to the spatial dimensions of the NJDM inputs. This dimensionality reduction can reduce the number of random variables input into NJDM 120, improving computational efficiency of the system. For instance, inputs to the NJDM 120 can include dimensionally reduced dynamical weather forecasts as well dimensionally reduced lagged weather predictors. The NJDM 120 can be capable of computing or simulating any random variable, such as a set of latent variables 118 that can be generated using sparse PCA (e.g., principal component analyzer 116) that represent dynamical weather forecasts and lagged weather variables. The number of latent variables 118 can set or limited by dimensionality constraints of the NJDM 120. The example system 200 can simulate large-scale weather patterns (e.g., of more than 1000 km in size) using only a few (e.g., about 6-12) latent variables.

The system 200 can combine the adjusted or configured statistical computations of the NJDM 120 with a diffusion based deep learning model (e.g., 130) to add back to the forecast outputs 144, the remaining variance (e.g., small scale weather patterns that are less than 1000 km in size). Diffusion models 130 can be used to model complex data distributions by iteratively denoising random noise into realistic outputs. Such an iterative process can allow diffusion models 130 to capture fine-grained details, allowing them to add back, to the output, the small-scale weather patterns on top of the generalized or averaged NDJM predictions. The integration of NJDM with the diffusion model allows the example system 200 (e.g., the hybrid diffusion system) to take advantage of both the NJDM approach that can provide the accuracy of large-scale weather patterns and the diffusion model 130 guiding the sampling process with small scale variations in the weather patterns within the output spatial range. The resulting forecast outputs 144 can include daily average surface weather characteristics or predictions for up to, for example, 35 or more days in the future or short-term (e.g., hourly) forecasts over the same spatial range.

Example system 200 can include a network 101 connecting the client device 102, the meteorological database 106 and the data processing system 110. Network 101 can be used by the weather application 104 of the user interface 216 to access the functionalities of the data processing system 110. For instance, a user interface 216 of the weather application 104 can be used by a user to provide parameters or settings for weather forecast to be used by the data processing system 110 functionalities (e.g., NJDM 120 or weather forecaster 140) to provide forecast outputs 144. For instance, a user can request, via the user interface 216, forecast outputs 144 which the data processing system 110 can generate using the weather data 108 of the meteorological database 106. The weather application 104 can display to the user of the client device 102 the weather outputs 144, via a user interface 216 (e.g., a graphical user interface).

As discussed in connection with example system 100, the NJDM 120 can include any combination of hardware and software for providing statistical modeling for processing weather data. NJDM 120 can utilize various statistical techniques to generate samples that reflect the underlying statistical properties of the data, such as correlations and marginal distributions in connection with the weather data 108. In addition to the functionalities discussed in FIG. 1, NJDM 120 can incorporate components such as data samplers 202, distribution determiners 204, correlation determiners 208 and correlation stabilizers 212 to improve its statistical modeling. For example, NJDM 120 can apply the Nataf transformation of the Nataf function 122 to convert marginal distributions into standard normal distributions, facilitating simpler and more compute efficient manipulation and analysis of the data. By integrating these features, NJDM 120 aims to provide accurate and reliable weather forecasts while improving the system's computational and energy efficiencies.

Data sampler 202 can include any combination of hardware and software configured for accessing or obtaining representative samples from multivariate distributions within a dataset (e.g., weather data 108). A multivariate distribution can be any probability distribution that describes a joint behavior of two or more random variables, capturing their relationships and dependencies. For example, a multivariate distribution can represent a joint distribution of temperature, humidity, and wind speed, illustrating how these variables interact and vary together over time. For instance, a data sampler 202 can obtain a sample (e.g., a subset of weather data instances), such as a selection of temperature and humidity readings taken from various locations over a specific time period.

Data sampler 202 can include the functionality to facilitate the samples to accurately reflect or correspond to the marginal distributions and correlations of the variables of the dataset. A marginal distribution can include any probability distribution of a subset of variables within a larger multivariate distribution, which can be obtained by integrating or summing out the other variables. For example, a marginal distribution of temperature can represent the probability distribution of temperature values independently of other variables, such as humidity or wind speed. Data sampler 202 can utilize techniques such as stratified sampling or random sampling to represent or capture the diversity of conditions present in the dataset. For instance, data sampler 202 can select or produce samples based on specific temperature thresholds or humidity levels to check that all relevant scenarios are considered in subsequent analyses.

Distribution determiner 204 can include any combination of hardware and software for estimating the marginal distributions for each variable in the dataset or determining the parameters for such marginal distributions. Distribution determiner 204 can include the functionality to determine the behavior of each variable independently and its relationships with any other variable in the multivariate context of the weather data 108. Distribution determiner 204 can fit various types of distributions, such as normal, lognormal, Johnson SU, and others. Distribution determiner 204 implement such distribution fits using techniques, such as the maximum likelihood estimation (MLE). For example, distribution determiner 204 can estimate distribution parameters 206, such as a mean and variance for a normal distribution or location and scale parameters for a Johnson SU distribution.

In addition to the features discussed in connection with example system 100 of FIG. 1, the Nataf function 122 can include any mathematical transformations used to convert marginal distributions into standard normal distributions while preserving correlations among variables. Nataf function 122 can include the functionality to improve the computational efficiency of the determinations or processes utilized. For instance, Nataf function 122 can implement enhancements such as improved algorithms for determining or refining transformation parameters and handling non-standard distributions more effectively. For instance, Nataf function 122 can utilize iterative methods to refine its estimates based on observed data characteristics and relationships or correlations between the variables or weather characteristics 142.

Correlation determiner 208 can be any mechanism designed to compute and analyze correlation matrices among variables in the weather dataset. The correlation determiner 208 can be configured to determine how different weather data variables interact with one another, determine their correlations and relations and maintain and include such relationships in statistical models. For example, correlation determiner 208 can calculate Pearson correlation coefficients or other measures of association to create a comprehensive correlation matrix that reflects original structures present in the data (e.g., correlation or relations between various variables or characteristics. For example, the correlation determiner 208 can utilize the Pearson correlation to identify the level of correlations between certain weather characteristics 142, such as the temperature and humidity levels. The NJDM 120 and the diffusion model 130 can utilize these correlations or relationships to determine the predictive modeling outcome in the forecast output 144.

Correlation matrices 210 can be any structured representation (e.g., array of values) of indicative of relations or correlations between multiple variables or groups of variables within a dataset. Correlation matrices 210 can include information indicative of level of relations between different variables corresponding to specific weather characteristics 142. For instance, correlation matrix 210 can indicate a correlation between humidity levels and wind speed at a particular location in a geographical area or quantify relationships between any weather variables or characteristics. Correlation determiner 208 or correlation stabilizer can adjust the correlation matrices 210 based on findings from analyses conducted by other components. For instance, if initial calculations indicate that some correlations are not positive definite, correlation stabilizer 212 can make adjustments to maintain positive definiteness and facilitate desired interpretations of relationships among variables by processing circuitry (e.g., GPUs).

Correlation stabilizer 212 can include any combination of hardware and software for correction or adjustment of correlation matrices 210. Correlation stabilizer 212 can include a module configured to implement or maintain the state of positive definiteness in the correlation matrices 210. For instance, the correlation stabilizer 212 can make adjustments or corrections to entries of a correlation matrix 210 to correct any eigenvalue of the correlation matrix 210 from a negative value to a non-negative value (e.g., zero or a positive number). In doing so, the correction stabilizer 212 can maintain the positive definiteness of the correlation matrix 210 during transformations and adjustments. Because non-positive definite matrices can lead to unreliable statistical results and poor model performance, the correlation stabilizer 212 can stabilize the system (e.g., weather forecaster 140) by converting the correlation matrices 210 into positive definite matrices.

Correlation stabilizer 212 can correct or adjust eigendecomposition (e.g., correct eigenvalues or eigenvectors obtained from eigendecomposition of a matrix). Eigendecomposition can include any operation or computation involving breaking down a square matrix into constituent parts of that matrix, such as the eigenvalues and eigenvectors. Eigendecomposition can be used to represent a matrix in a simpler form to facilitate reduction in computational resources and processing efficiency. Correlation stabilizer 212 can adjust eigenvalues or eigenvectors to preserve positive definiteness of a correlation matrix 210, while preserving the characteristics of correlations. For example, the correlation stabilizer 212 can symmetrize a matrix or adjust eigenvalues to ensure that all values remain positive during processing. By implementing such operations, the correlation stabilizer 212 can improve the robustness and reliability of statistical modeling of the NJDM 120, avoid computational errors or indefinite outputs and improve the processing efficiency.

As discussed in connection with FIG. 1, the 2D array generator 124 can be configured to construct or generate 2D arrays 126. The 2D arrays 126 can include or be generated using random samples from specified distributions while preserving correlations among variables. For instance, the 2D array generator 124 can generate 2D arrays 126 using any statistical distributions from which random samples are drawn, such as normal distributions, uniform distributions, or Johnson SU distributions. These distributions can be used to create 2D arrays 126 that reflect the specific or intended weather characteristics 142 and the correlations among such characteristics or their weather variables. For instance, the 2D array generator can generate a 2D array of temperature and humidity samples that follow a normal distribution while maintaining the correlation between the temperature and the humidity (e.g., weather characteristics 142) based on the correlation matrix 210 defining the relations for these variables for given locations or areas.

Array generator 124 can generate inputs for various statistical models within NJDM 120 by producing structured datasets that reflect underlying relationships among weather variables. For example, a 2D array generator 124 can produce structured datasets by generating random samples of temperature and humidity from a multivariate normal distribution. In doing so, the array generator 124 can select or generate the samples from the distribution curve such as that they are based on, include, indicate or correspond to the inherent correlations between these weather variables (e.g., variables generated from the distribution curves corresponding to the weather characteristics) while maintaining the respective marginal distributions.

Array generator 124 can incorporate sampling techniques such as Cholesky decomposition to generate the samples according to maintained statistical properties of marginal distributions and correlations. Cholesky decomposition can include a computation that factors a Hermitian, positive-definite matrix into a product of a lower triangular matrix and a conjugate transpose of that lower triangular matrix. Such computation can be used for generation of samples that maintain specified correlations (e.g., expressed by the correlation matrix 210), allowing for the simulation of correlated random variables by transforming uncorrelated random samples through the Cholesky factorization of their covariance matrix. For instance, the array generator 124 can utilize Cholesky decomposition to produce a matrix representing temperature and humidity levels over time, which could then be used for predictive modeling tasks. By providing these structured datasets efficiently, the 2D array generator supports effective analyses within weather forecasting systems.

Matrix decomposer 214 can include any combination of hardware and software for breaking down matrices into simpler forms suitable for further analysis or computations. For example, a matrix decomposer 214 can implement Cholesky decomposition to factor a covariance matrix into a lower triangular matrix. In doing so, the matrix decomposer 214 can allow for the generation of correlated random samples for weather variables, which can then be used in predictive modeling tasks. Matrix decomposer 214 can be utilized when dealing with high-dimensional datasets where direct manipulation may not be feasible or impractical due to computational constraints or numerical instability. Matrix decomposer 214 can implement decomposition techniques such as Lower-Upper (LU) decomposition or Cholesky decomposition to facilitate operations on matrices (e.g., correlation matrices 210) while preserving their internal relations or properties. For example, matrix decomposer 214 can decompose a large covariance matrix into lower triangular forms that simplify calculations involved in generating correlated random samples, allowing for more compute efficient processing.

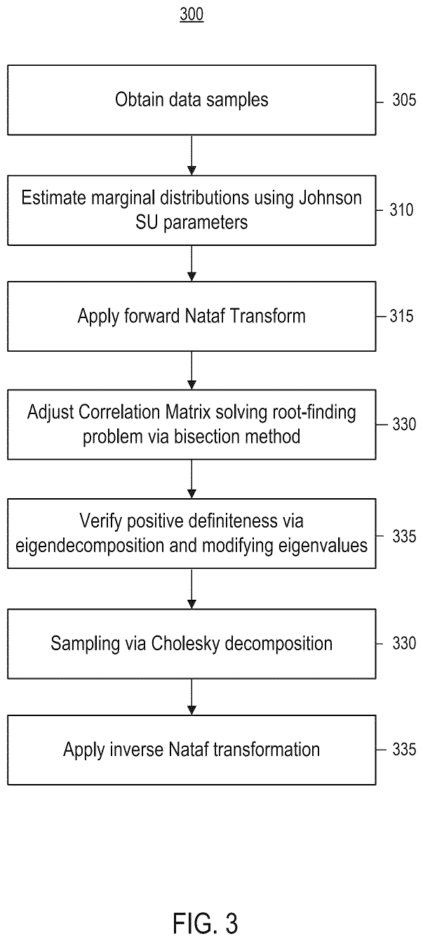

FIG. 3 illustrates an example flowchart of a method 300 for providing a compute efficient adjusted Nataf transformation for a long-term weather forecast. The method 300 can be implemented using one or more processors (e.g., 510) that can be configured, via instructions or data stored in memory, such as memory (e.g., 515) of one or more servers or devices implemented using a computing environment or system, such as the computing system 500 of FIG. 5. The method 300 can be performed, for example, by one or more components of system 100 of FIG. 1 or system 200 of FIG. 2, which can be implemented using one or more computing systems 500 depicted in FIG. 5. Method 300 can include ACTS 305-335. At ACT 305, the method can include obtaining data samples. At 310, the method can determine marginal distributions using Johnson unbounded support (SU) parameters. At 315, the method can apply forwards Nataf transform. At 320, the method can adjust correlation matrix solving root-finding problem via bisection method. At 325, the method can verify positive definiteness via eigendecomposition and modifying eigenvalues. At 330, the method can implement sampling via Cholesky decomposition. At 335, the method can apply inverse Nataf transformation.

At 305, the method can include obtaining data samples. For instance, the samples for a multivariate distribution of interest can be obtained from a database or a meteorological station. These samples can include, for example, hourly, daily or weekly variables whose values can be indicative of weather conditions over a geographical area, such as for example, values for temperature, pressure, humidity, precipitation, solar radiation, or other variables. The samples can provide information about the marginal distributions of each variable and their correlations. In some applications, the dimensionality (number of variables, N) can be very high, often reaching thousands. Accordingly, datasets of weather variables can be large and detailed.

The method can include identifying a dataset comprising variables that are indicative of characteristics of weather. The data set can correspond to variables captured or taken during a first time interval, such as one or more hours, days, weeks or months. The dataset can include historical weather data collected from a meteorological station. The characteristics of weather can correspond to at least one of: pressure, temperature, saturation vapor pressure, vapor pressure deficit, specific humidity, air density, cloud coverage, and wind speed.

At 310, the method can utilize a flexible probability distribution framework to accommodates a wide range of data characteristics. For instance, the method can estimate marginal distributions using Johnson unbounded support (SU) parameters. The marginal distributions can be estimated such that for each of the N variables, an assumed analytic form for the marginal probability density function (PDF) can be fit and parameters can be estimated. For example, a Pearson correlation coefficient can be computed for all pairs of variables to construct the (N, N) correlation matrix (e.g., \rho_x).

The method can model each marginal distribution using the Johnson SU distribution, taking advantage of the flexibility of this distribution. For instance, for each variable, the system can fit a Johnson SU distribution, which can be configured for modeling the phenomena encountered in weather data. The fitting process can include a two-stage probability-weighted moment (PWM) matching method. The fitting process can optimize a maximum likelihood estimation (MLE) parameters using the Broyden-Fletcher-Goldfarb-Shanno (BFGS) algorithm. The fitting process can then refine the fit using the Levenberg-Marquardt algorithm for the PWM objective function. This process can be fully parallelized and GPU-accelerated, allowing for efficient processing of thousands of distributions simultaneously.

For example, the method can include determining parameters of marginal distributions of the variables based on the dataset identified or received at act 305. The parameters of marginal distributions can be determined using a first function for maximum likelihood estimation and a second function for probability weighted moment matching of the parameters. For instance, the distribution can include a Johnson SU probability distribution and the first function for maximum likelihood estimation can be implemented using a gradient-based adjustment of the parameters. For example, the gradient-based adjustment can be implemented using at least one of a function for Broyden-Fletcher-Goldfarb-Shanno (BFGS) operation or a function for Levenberg-Marquardt operation. For example, the second function can utilize a Hessian matrix to iteratively refine the parameters. The parameters can be refined using at least one second-order computation.

At 315, the method can apply a forward Nataf transform. For instance, a forward Nataf transform can be applied to the outputs from act 210. For instance, the solution can transform each marginal distribution to a standard normal distribution by applying the CDF of the marginals followed by the inverse CDF of the standard normal. This step can map each variable independently to the standard normal space, temporarily ignoring correlations.

At 320, the method can adjust correlation matrix solving root-finding problem via bisection method. The method can include constructing a correlation matrix configured for parallel processing. The correlation matrix can be constructed based on the variables of the dataset received or identified at act 305. For instance, the method can normalize the probability distributions and construct the correlation matrix based on the variables of the dataset. For instance, the method can determine values of the correlation matrix using a Pearson's correlation coefficient.

The correlation matrix can be adjusted. For instance, the correlation matrix in the transformed (e.g., standard normal) space, (e.g., \rho_z), can be adjusted to match the original correlation structure (e.g., \rho_x). The method can compute Pearson correlation coefficients for all variable pairs, constructing an initial correlation matrix ρx. Following this, the forward Nataf transform can be applied, transforming each marginal distribution to a standard normal distribution and mapping each variable independently to the standard normal space. The correlation matrix in the transformed space (ρz) can then be adjusted to match the original correlation structure. This adjustment can be performed using a GPU-accelerated numerical solution based on established mathematical models, implementing the bisection method for efficient root-finding numerical computation. These computations can be GPU-accelerated, allowing for rapid processing of correlation coefficients, even when N2 reaches into hundreds of millions.

At 325, the method can verify positive definiteness via eigendecomposition and modifying eigenvalues. For instance, a positive definiteness can be implemented or applied to the correlation matrix. The solution can modify the transformed correlation matrix to the nearest positive definite matrix, as desired, which can help validate the multivariate normal sampling. This can be done using matrix projection techniques. For example, the method can identify at least an entry of the correlation matrix corresponding to an eigenvalue that has a negative value. The method can modify the entry of the correlation matrix into a non-negative value to achieve positive definiteness of the correlation matrix.

To validate the transformed correlation matrix, the method can apply a series of steps to check for positive definiteness. This can include matrix symmetrization, eigendecomposition, negative eigenvalue replacement, matrix reconstruction, and the addition of a small multiple of the identity matrix. For instance, the method can symmetrize the input matrix by averaging it with its transpose. The method can compute the eigendecomposition of the symmetrized matrix. The method can replace any negative eigenvalues with zero. The method can reconstruct the matrix using the modified eigenvalues. The method can add a small multiple of the identity matrix if needed to secure positive definiteness of the variables of the correlation matrix (e.g., providing positive definiteness of the correlation matrix).

At 330, method can utilize matrix factorization techniques for sampling, facilitating the generation of samples from multivariate distributions. For instance, the method can implement sampling via Cholesky decomposition. Cholesky decomposition can be used for sample generation. The technical solutions can perform Cholesky decomposition on the adjusted correlation matrix to generate samples from the inferred multivariate normal distribution in the transformed space. For instance, once the matrix is optimized (e.g., using the above steps), the system can perform Cholesky decomposition on the adjusted correlation matrix to generate samples from the inferred multivariate normal distribution.

The method can generate predicted sample of variables for a weather forecast indicating the characteristics of weather during a second time interval. The second time interval can correspond to a future time interval, such as a future sequence of 20, 30, 50, 100, 180, 365 or more days. The generation of predicted samples of variables for weather forecast can be implemented via parallel processing and can be based on the correlation matrix. For example, the method can construct, based on the correlation matrix, a second matrix corresponding to correlated random variables. The method can generate, using the second matrix, a plurality of samples comprising the sample, the plurality of samples corresponding to the characteristics of weather. The method can generate, based on the plurality of samples, the weather forecast indicating the characteristics of weather during the second time interval.

At 335, inverse Nataf transformation can be applied to provide a weather forecast output. For instance, the technical solutions can apply the inverse Nataf transform to map these samples back to the original space, preserving the intended marginal distributions and correlations. For instance, if at act 315, the Nataf forward transformation utilized a particular format, number or arrangement of variables, at this stage the method can revert back to the same format or the same number or arrangement of variables.

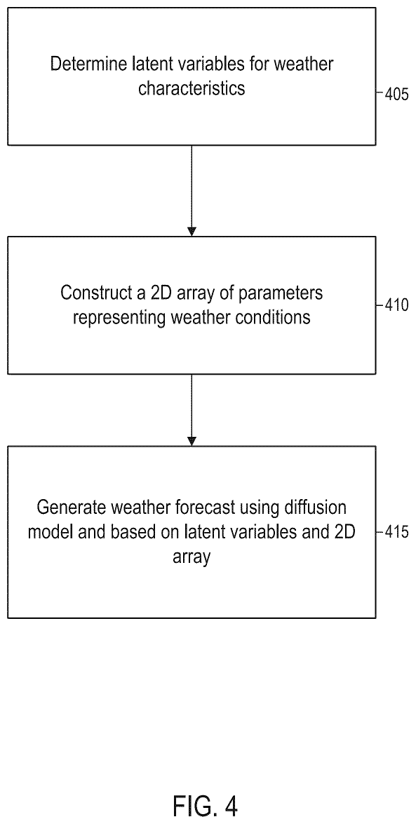

FIG. 4 depicts an example flowchart of a method 400 for providing, implementing or using a long-term weather forecasting framework using statistical machine learning modeling. The method 400 can be implemented using one or more processors (e.g., 510) that can be configured, via instructions or data stored in memory, such as memory (e.g., 515) of one or more servers or devices implemented using a computing environment or system, such as the computing system 500 of FIG. 5. The method 400 can be performed, for example, by one or more components of system 100 of FIG. 1 or system 200 of FIG. 2, which can be implemented using one or more computing systems 500 depicted in FIG. 5. Method 400 can include ACTS 405-415. At ACT 405, the method can determine latent variables for weather characteristics. At 410, the method can construct a 2D array of parameters representing weather conditions. At 415, the method can generate weather forecast a diffusion model and based on the latent variables and the 2D array.

At ACT 405, the method can determine latent variables for weather characteristics. The method can include one or more processors coupled with memory determining latent variables corresponding to characteristics of weather over the time interval in the geographical area. The method can include determining the latent variables based on, or using, a principle component analysis (PCA) by a principal component analyzer. The principal component analysis can include an operation or a computation for reducing dimensionality to transforms a set of correlated variables into a smaller set of uncorrelated variables (e.g., principal components). The principal components can capture or indicate the maximum variance in the data. The PCA can be used for generating the latent variables by computing linear combinations of the original variables based on their eigenvectors, summarizing patterns in the dataset of the larger number of variables.

The method can include generating, using the one or more marginal distributions, constraints for the latent variables and applying the constraints to the latent variables. The constraints can maintain the latent variables within a predetermined range of expected values. The constraints can include at least one of: constraints for the characteristics of weather, a constraint for a relationship between two or more values of the two or more characteristics of weather, or a constraint for a temporal-spatial change for a value over a time period or a distance of space.

At 410, the method can construct a 2D array of parameters representing weather conditions. The method can include the one or more processors constructing a two-dimensional (2D) array of parameters. The 2D array can represent weather conditions or characteristics over a time interval in a geographical area. The 2D array can be constructed using a non-parametric joint distribution model (NJDM). The NJDM can include one or more statistical operations or computations to construct one or more 2D arrays by generating random samples from specified distributions. The generated samples can preserve the correlations among the variables of the weather data, allowing for effective modeling and analysis of complex weather patterns using parallel computation of the samples by separate processors (e.g., one or more GPUs).

The method can include identifying, from a database of meteorological data, the parameters corresponding to at least one of: temperature, wind, humidity or a total column water vapor. The method can include determining one or more marginal distributions for each of the parameters and determining or generating one or more correlation matrices identifying relationships between the parameters.

The method can include the one or more processors adjusting, within the one or more correlation matrices, eigenvalues corresponding to the parameters to achieve positive definiteness of the one or more correlation matrices. The eigenvalues can be entries of a correlation matrix. The method can include adjusting the eigenvectors of the correlation matrix. The eigenvalues and the eigenvectors can be adjusted to facilitate or achieve positive definiteness of the correlation matrix.

The one or more processors can construct, using the NJDM, a joint distribution of the parameters indicative of interdependencies between the parameters and determine the latent variables, using the PCA applied to the joint distribution. The 2D array can include a plurality of rows and a plurality of columns. Each entry of each individual row of the plurality of rows and each individual column of the plurality of columns can corresponds to a parameter of the plurality of parameters. These parameters can include or correspond to at least one of: pressure, temperature, saturation vapor pressure, vapor pressure deficit, specific humidity, air density, and wind speed.

At 415, the method can generate weather forecast a diffusion model and based on the latent variables and the 2D array. The method can include the one or more processors generating one or more predictions of 2D characteristics of weather (e.g., 2D representation of the weather forecast for a geographical area). The one or more predictions can be weather forecasts for time periods within a second time interval and for the geographical area. The time periods can include daily forecasts for a second time period of more than 10, 20, 30, 50, 100, 200, 365 or more than 365 days. The predictions of 2D characteristics of weather can be generated using a diffusion model. For instance, a weather forecaster can utilize or trigger a deep learning diffusion model based on the latent variables and the 2D array input into the diffusion model. The diffusion model can be trained to generate the 2D representations (e.g., images or simulations) of the representations of weather (e.g., weather characteristics), such as solar radiation, wind speed and direction, pressure, temperature, saturation vapor pressure, vapor pressure deficit, specific humidity.

The one or more predictions can include 2D representations of weather characteristics including parameters indicative of at least one of: temperature, wind components and humidity. The 2D characteristics of weather can correspond to daily predictions of weather in the geographical area for the second time interval of at least a sequence of consecutive days, such as 30 consecutive days, or consecutive days or weeks of one or more months or one or more years. The weather forecast can be a forecast for a geographical area of up to 10, 20, 50, 100, 200, 1000 or more than a 1000 of square kilometers.

The weather forecaster can utilize the diffusion model to generate the 2D weather forecast. The diffusion model can be a deep learning machine learning model trained using data indicative of the characteristics of weather for a plurality of weather representations within a plurality of time periods and a plurality of geographical areas. The one or more processors can utilize at least one of the NJDM or the diffusion model to determine, based on the 2D array, representations of trends of weather in the geographical area. For instance, the trends of weather can be included in an averaged or smoothed 2D array generated by the NJDM. The weather forecaster can determine based on the 2D array and the latent variables input into the diffusion model, representations of variations within the trends of weather. The diffusion model can combine the representations of trends of weather and the representations of variations within the trends of weather to generate the one or more predictions of 2D characteristics of weather (e.g., 2D representations of sequence of daily weather forecasts).

FIG. 5 depicts an example block diagram of a computing system 500, also referred to as the computing device 500, which can be included, deployed or coupled with any device performing functions discussed herein. Computing system 500 can be included, for example, on one or more servers or devices providing any of the features or functionality of the client 102 or a data processing system 110. Computing system 500 can include or be used in conjunction with any data or information processing, communication, or any functions discussed in connection with FIGS. 1-3 or any actions or acts discussed in connection with FIGS. 1-3.

Computing system 500 can include one or more data buses 505 for conducting signals, data or information between one or more processors 510, main memories 515, read only memories (ROM) 520, storage devices 525, input devices 530 or output devices 535. A data bus 505 can include data lines, wiring, conducting lines or a network or wired or wireless signals for exchanging data between the components of the computing system 500.

Computing system 500 can also include one or more processors 510 (e.g., controllers, digital signal processors, central processing units or otherwise processing circuits) that can be coupled or integrated with the data bus 505 to process data or information that can be stored in various types of memory circuits on the computing system 500.

Computing system 500 can store commands or instructions or data (e.g., weather data 108 or latent variables 118) in various types and forms of memory or storage devices, which can be used for implementing the technical solutions. For example, computing system 500 can store data in at least one main memory 515. Main memory 515 can include a random access memory (RAM), such as a dynamic RAM (DRAM) or static RAM (SRAM), or any other type of RAM memory, which can be used for dynamic data storage. Main memory 515 can be coupled to the data bus 505 to exchange stored information, instructions or data to with the processor 510 or other computing system components (e.g., input device 530 or output device 535). Main memory 515 can be used for storing data, instructions or information during execution of instructions by the processor 510. Computing system 500 can further include at least one read only memory (ROM) 520 or other static storage device coupled to the data bus 505 for storing static information, such as computer code, executable functions, data or instructions that can be used by the processor 510. A storage device 525, such as a solid state device (SSD), flash storage devices, magnetic or optical disks or any other storage devices can be coupled to the data bus 505 to store information, data, computer code or instructions. For example, the storage device 525 may be implemented as a non-transitory medium, such as a solid-state drive or flash memory, that stores processor-executable instructions for the weather forecasting operations described herein. When executed by processor 510, these instructions can cause the computing system 500 to perform tasks such as retrieving weather data, constructing correlation matrices, or generating forecast outputs, as discussed herein.

Computing system 500 can include one or more input devices 530 and output devices 535. An output device 535 that can be coupled with other computing system 500 components via the data bus 505. Output device 535 can include any type and form of device for providing output from the computing system 500, including for example a display (e.g., an OLED, LCD or other display) for displaying information to a user, speakers for outputting sound data, printers for printing information, projectors, network interface devices for communicating data over a network or any other type of output device 535 that can output information from the computing system 500. An input device 530, such as a physical or a display keyboard, a touch display, a voice interface, mouse or cursor control device, a microphone or any other data or information input device. Input device 530 can be coupled to the data bus 505 for exchanging information, instructions and commands with the processor 510.

The processes, systems and methods described herein can be implemented by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes described herein. One or more processors in a multi-processing arrangement may also be employed to execute the instructions contained in main memory 515. Hard-wired circuitry can be used in place of or in combination with software instructions together with the systems and methods described herein. Systems and methods described herein are not limited to any specific combination of hardware circuitry and software.

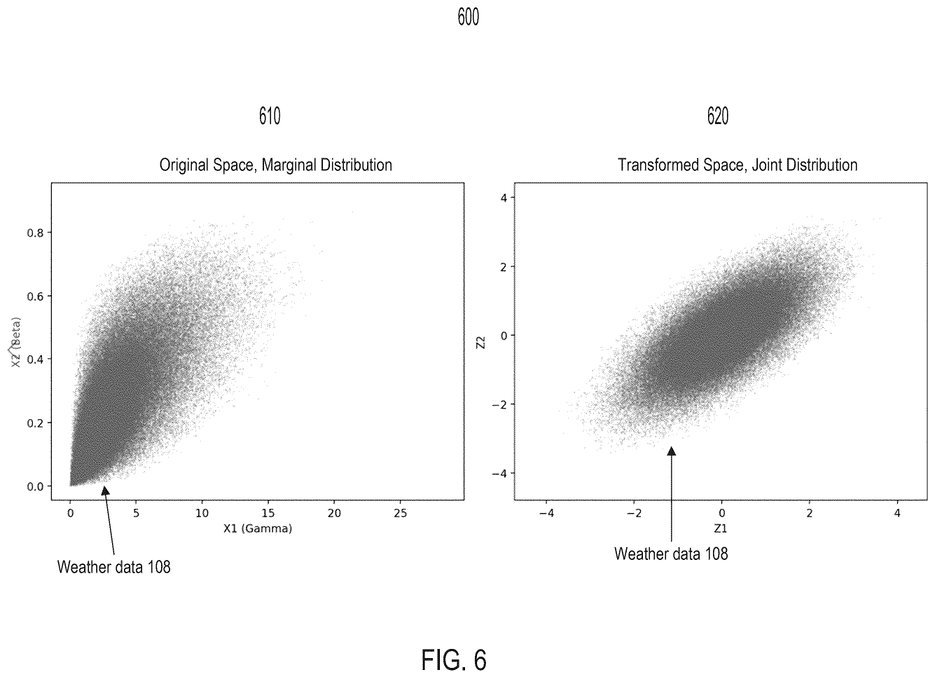

FIG. 6 illustrates an example pair of plots 610 and 620 of variables of weather data 108 in the original space (e.g., 610) and in the transformed space (e.g., 620). The plot 610 shows a plot of two random variables (e.g., x1 and x2) to show the marginal distributions and the joint distributions. The marginal distribution can be a gamma distribution (x1) and the Beta distribution (x2). Each dot in plot 610 can correspond to a sample from the joint distribution p(x1, x2).

Referring now to plot 620 an example of a transformed space is illustrated. Using the Using the Nataf transformation, each of the samples plotted in 610 can be transformed to a standard normal space (Z1, Z2), in which the samples can be normally (e.g., Gaussian) distributed. However, when computing a Pearson correlation coefficient for two different sets of samples at 610 plot, different results can be provided. To address such issues, a correlation transform (e.g., correlation matrix) can be utilized.

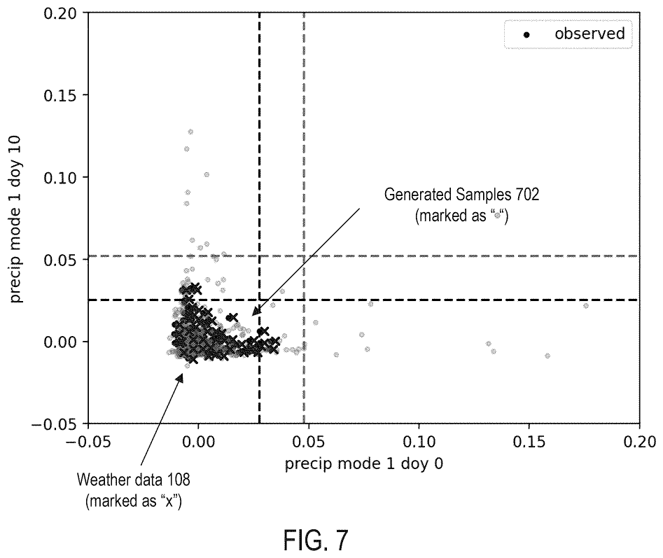

FIG. 7 illustrates an example plot 700 of an example set of variables from the weather data 108, such as variables for precipitation on a particular day at a particular location (e.g., variables (x1, x2). The black dots with black “x” marks show historical observations on different years for the same day. The plotted data can correspond to a joint distribution in an original space. The corresponding variables in the standard normal space are not shown.

The technical solutions can utilize or train an NJDM using the marginal distributions represented using Johnson SU distributions, and the result can include generating any number of generated samples 702. The generated samples 702 can be samples generated using the NJDM 120 and can be marked as samples (e.g., gray dots) whose generated distribution can match the observed data. In plot 700, some of the generated samples 702 (e.g., gray dots) can obscure the observed weather data 108 variables (e.g., “x” marked black dots), as both the variables of the weather data 108 and the generated sample 702 values are plotted together on the same graph.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C #, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit).

Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system, comprising:
one or more processors, coupled with memory, to:
identify a dataset comprising variables indicative of characteristics of weather during a first time interval;
determine, based on the dataset, parameters of marginal distributions of the variables using a first function for maximum likelihood estimation and a second function for probability weighted moment matching of the parameters;
construct, based on the variables, a correlation matrix configured for parallel processing;
generate, via parallel processing by the one or more processors and based on the correlation matrix, predicted sample of variables for a weather forecast indicating the characteristics of weather during a second time interval; and
provide, for display, the predicted sample of variables for the weather forecast via a user interface.

2. The system of claim 1, wherein the dataset comprises historical weather data collected from a meteorological station and the characteristics of weather correspond to at least one of: pressure, temperature, saturation vapor pressure, vapor pressure deficit, specific humidity, air density, cloud coverage, and wind speed.

3. The system of claim 1, wherein the distribution includes a Johnson SU probability distribution and the first function for maximum likelihood estimation is implemented using a gradient-based adjustment of the parameters.

4. The system of claim 3, wherein the gradient-based adjustment is implemented using at least one of a function for Broyden-Fletcher-Goldfarb-Shanno (BFGS) operation or a function for Levenberg-Marquardt operation.

5. The system of claim 1, wherein the second function utilizes a Hessian matrix to iteratively refine the parameters using at least one second-order computation.

6. The system of claim 1, wherein the one or more processors are configured to:
normalize the probability distributions; and
construct the correlation matrix based on the variables of the dataset.

7. The system of claim 6, wherein the one or more processors are configured to determine values of the correlation matrix using a Pearson's correlation coefficient.

8. The system of claim 1, wherein the one or more processors are configured to:
identify at least an entry of the correlation matrix corresponding to an eigenvalue that has a negative value; and
modify the entry of the correlation matrix into a non-negative value to achieve positive definiteness of the correlation matrix.

9. The system of claim 1, comprising the one or more processors to:
construct, based on the correlation matrix, a second matrix corresponding to correlated random variables;
generate, using the second matrix, a plurality of samples comprising the sample, the plurality of samples corresponding to the characteristics of weather; and
generate, based on the plurality of samples, the weather forecast indicating the characteristics of weather during the second time interval.

10. The system of claim 1, wherein the one or more processors are configured to:
identify, from the one or more processors, a plurality of processors to perform the parallel processing;
determine a plurality of portions of predicted variables to process by the plurality of processors via parallel processing; and
generate, by each processor of the plurality of processors during a same one or more processing cycles, a respective portion of the plurality of portions of predicted variables.

11. The system of claim 1, wherein the one or more processors are configured to:
determine, based on at least a subset of the predicted variables, forecast of wind movement in a geographical area during the second time interval; and
identify, based on the forecast of the wind movement, a location within the geographical area in which the wind movement satisfies a constraint for a wind power plant.

12. The system of claim 1, wherein the one or more processors are configured to:
determine, based on at least a subset of the predicted variables, forecast of sunny weather in a geographical area during the second time interval; and
identify, based on the forecast of the sunny weather, a location within the geographical area in which the sunny weather satisfies a constraint for a solar power plant.

13. The system of claim 1, wherein the one or more processors are configured to:
determine, based on at least a subset of the predicted variables, forecast of precipitation in a geographical area during the second time interval; and
identify, based on the forecast of precipitation, a location within the geographical area in which the precipitation satisfies a constraint for an agricultural farm.

14. A method, comprising:
identifying, by one or more processors coupled with memory, a dataset comprising variables indicative of characteristics of weather during a first time interval;
determining, by the one or more processors, based on the dataset, parameters of marginal distributions of the variables using a first function for maximum likelihood estimation and a second function for probability weighted moment matching of the parameters;
constructing, by the one or more processors, based on the variables, a correlation matrix configured for parallel processing;
generating, by the one or more processors, via parallel processing by the one or more processors and based on the correlation matrix, predicted sample of variables for a weather forecast indicating the characteristics of weather during a second time interval; and
providing, by the one or more processors, for display, the predicted sample of variables for the weather forecast via a user interface.

15. The method of claim 14, wherein the dataset comprises historical weather data collected from a meteorological station and the characteristics of weather correspond to at least one of: pressure, temperature, saturation vapor pressure, vapor pressure deficit, specific humidity, air density, cloud coverage, and wind speed.

16. The method of claim 14, wherein the distribution includes a Johnson SU probability distribution and the first function for maximum likelihood estimation is implemented using a gradient-based adjustment of the parameters.

17. The method of claim 16, comprising:
implementing, by the one or more processors, the gradient-based adjustment using at least one of a function for Broyden-Fletcher-Goldfarb-Shanno (BFGS) operation or a function for Levenberg-Marquardt operation.

18. The method of claim 14, comprising:
using, by the one or more processors, a Hessian matrix to iteratively refine the parameters using at least one second-order computation.

19. The method of claim 14, comprising:
normalizing, by the one or more processors, the probability distributions; and
constructing, by the one or more processors, the correlation matrix based on the variables of the dataset.

20. A non-transitory computer-readable medium storing processor-executable instructions that, when executed by one or more processors, cause the one or more processors to:
identify a dataset comprising variables indicative of characteristics of weather during a first time interval;
determine, based on the dataset, parameters of marginal distributions of the variables using a first function for maximum likelihood estimation and a second function for probability weighted moment matching of the parameters;
construct, based on the variables, a correlation matrix configured for parallel processing;
generate, via parallel processing by the one or more processors and based on the correlation matrix, predicted sample of variables for a weather forecast indicating the characteristics of weather during a second time interval; and
provide, for display, the predicted sample of variables for the weather forecast via a user interface.
